(19) United States
(12) Patent Application Publication
(10) Pub. No.: US 2024/0412054 A1
(43) Pub. Date: Dec. 12, 2024

(54) USING MEMORY TO AUGMENT SELF-ATTENTION IN NEURAL NETWORKS

(71) Applicant: Google LLC, Mountain View, CA (US)

(72) Inventors: Christian Szegedy, Mountain View, CA (US); DeLesley Stuart Hutchins, Campbell, CA (US); Markus Norman Rabe, San Francisco, CA (US); Yuhuai Wu, Los Altos, CA (US)

(21) Appl. No.: 18/697,211

(22) PCT Filed: Oct. 6, 2022
(86) PCT No.: PCT/US2022/045948

§ 371 Date: Mar. 29, 2024

Related U.S. Application Data
(60) Provisional application No. 63/252,616, filed on Oct. 6, 2021.

(51) Int. Cl. G06N 3/063; G06N 3/084

(52) U.S. Cl. CPC G06N 3/063; G06N 3/084

(57) ABSTRACT

Methods, systems, and apparatus, including computer programs encoded on a computer storage medium, for performing a machine learning task on a network input to generate a network output. In one aspect, one of the systems includes a neural network configured to perform the machine learning task, the neural network including one or more augmented neural network blocks. Each augmented network block applies two different attention mechanisms: a first attention mechanism over representations of the current network input and a second attention mechanism that is augmented with a memory that stores outputs previously generated by the first attention mechanism.

### CROSS-REFERENCE TO RELATED APPLICATIONS

This application claims the benefit of priority to U.S. Provisional Application Ser. No. 63/252,616, filed Oct. 6, 2021, the entirety of which is incorporated herein by reference.

### BACKGROUND

This specification relates to performing a machine learning task on a network input using neural networks.

Neural networks are machine learning models that employ one or more layers of nonlinear units to predict an output for a received input. Some neural networks include one or more hidden layers in addition to an output layer. The output of each hidden layer is used as input to the next layer in the network, i.e., the next hidden layer or the output layer. Each layer of the network generates an output from a received input in accordance with current values of a respective set of parameters.

### SUMMARY

This specification describes a system implemented as computer programs on one or more computers in one or more locations that generates network outputs for received network inputs using a neural network that includes one or more “augmented” self-attention neural network blocks.

Each augmented network block applies two different attention mechanisms: a first attention mechanism over representations of the current network input and a second attention mechanism that is augmented with a memory that stores outputs previously generated by the first attention mechanism.

Particular embodiments of the subject matter described in this specification can be implemented so as to realize one or more of the following advantages.

Some existing systems that apply self-attention to input sequences are constrained in the length of the input sequences that can be processed, i.e., constrained to processing input sequences have at most a certain number of elements. Here, an input sequence can refer to an input sequence for a task that is being performed or an already-generated portion of an output sequence that is required to be generated in order for the neural network to perform the task.

In particular, both the computational and memory requirements of applying self-attention across an entire input sequences grows quadratically with the number of elements in the input sequence (i.e., the computational and memory complexity is O(n²), where n is the number of elements in the input sequence). Thus, it can be infeasible to apply self-attention to an input sequence when n is too large, limiting these existing systems to small problem domains. For instance, some such existing systems are unable to effectively execute machine learning tasks on input sequences corresponding to entire books, long journal articles, technical math papers, source code of software applications, and so on.

Using techniques described in this specification, a system can apply self-attention to input sequences of arbitrary length by segmenting the input sequences into multiple subsequences and applying self-attention to the subsequences at respective stages. The system can maintain a memory of pairs of keys and values determined during respective stages. When applying self-attention to a new subsequence, for each element of the new subsequence, the system can obtain, from the memory, respective previous keys and values determined for the element at respective previous stages. Thus, the system can apply attention across elements of the input sequence that are far away from each other, i.e., that are in different respective subsequences.

In this way, the system can model long-term dependencies across the input sequence. For instance, if the system is configured to execute a machine learning task for an input sequence representing a book, the system can effectively apply self-attention to elements representing an entity (e.g., a character) of the book, even if long portions of the book (e.g., multiple chapters) separate appearances of the entity.

Some other existing systems apply self-attention to longer input sequences by attending, for each element of the input sequence, over every other element of the input sequence, over a predetermined set of preceding elements in the input sequence, or over a predetermined set of keys and value generated from the preceding elements in the input sequence. Using techniques described in this specification, a system can use the memory to dynamically select, for each element of the input sequence, one or more preceding elements in the input sequence with which the input element is likely to have a high attention output, i.e., that are likely to be related to the input element. That is, the system can select only a subset of the previous elements, thus significantly reducing the computational complexity of the system while improving performance of the neural network by allowing the neural network to dynamically select the subset that will be attended over.

Generally, when using the techniques described in this specification, the performance of the neural network improves as the size of the memory, i.e., the number of key-value pairs that can be stored in the memory, increases. That is, the size of the memory can be increased to maximally augment the self-attention mechanism described above. In other words, when deployed on a target set of one or more devices where a particular memory budget is allocated to the neural network, the size of the memory can be adjusted to maximize the memory budget, thereby maximizing the performance of the neural network on the target set of one or more devices.

More specifically, because the memory is non-differentiable during training, the size of the memory can be dynamically adjusted after training, i.e., to a different size than was used during training, to allow the neural network to be optimized for a given memory budget.

As described in this specification, a self-attention based neural network configured to process input sequences can require far fewer computations to achieve the same performance as a state-of-the-art convolutional neural network. That is, for a fixed compute budget, the self-attention based neural network performs better than the convolutional neural network. This is because applying self-attention is generally more computationally efficient than convolving a kernel across an entire sequence, as the self-attention mechanism is able to attend to different regions of the sequence with fewer computations than convolution.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 shows an example neural network system.

FIG. 2A is a flow diagram of an example process for processing a block input using an augmented block when the neural network generates an output sequence auto-regressively.

FIG. 2B is a flow diagram of an example process for processing a block input using an augmented block when the neural network generates a network output for a long input sequence.

FIG. 3 illustrates an example architecture of the neural network.

Like reference numbers and designations in the various drawings indicate like elements.

### DETAILED DESCRIPTION

This specification describes a system implemented as computer programs on one or more computers in one or more locations that performs a machine learning task on a network input to generate a network output for the machine learning task.

The machine learning task can be any machine learning task that operates on a network input that is an input sequence to generate a network output for the network input.

Some examples of machine learning tasks that the system can be configured to perform follow.

As one example, the task may be a neural machine translation task. For example, if the input to the neural network is a sequence of text, e.g., a sequence of words, phrases, characters, or word pieces, in one language, the output generated by the neural network may be a translation of the sequence of text into another language, i.e., a sequence of text in the other language that is a translation of the input sequence of text. As a particular example, the task may be a multi-lingual machine translation task, where a single neural network is configured to translate between multiple different source language—target language pairs. In this example, the source language text may be augmented with an identifier that indicates the target language into which the neural network should translate the source language text.

As another example, the task may be an audio processing task. For example, if the input to the neural network is a sequence representing a spoken utterance, the output generated by the neural network may be a score for each of a set of pieces of text, each score representing an estimated likelihood that the piece of text is the correct transcript for the utterance. As another example, if the input to the neural network is a sequence representing a spoken utterance, the output generated by the neural network can indicate whether a particular word or phrase (“hotword”) was spoken in the utterance. As another example, if the input to the neural network is a sequence representing a spoken utterance, the output generated by the neural network can identify the natural language in which the utterance was spoken.

As another example, the task can be a natural language processing or understanding task, e.g., an entailment task, a paraphrase task, a textual similarity task, a sentiment task, a sentence completion task, a grammaticality task, and so on, that operates on a sequence of text in some natural language.

As another example, the task can be a text to speech task, where the input is text in a natural language or features of text in a natural language and the network output is a spectrogram, a waveform, or other data defining audio of the text being spoken in the natural language.

As another example, the task can be a health prediction task, where the input is a sequence derived from electronic health record data for a patient and the output is a prediction that is relevant to the future health of the patient, e.g., a predicted treatment that should be prescribed to the patient, the likelihood that an adverse health event will occur to the patient, or a predicted diagnosis for the patient.

As another example, the task can be a text generation task, where the input is a sequence of text, and the output is another sequence of text, e.g., a completion of the input sequence of text, a response to a question posed in the input sequence, or a sequence of text that is about a topic specified by the first sequence of text. As another example, the input to the text generation task can be an input other than text, e.g., an image, and the output sequence can be text that describes the input.

As another example, the task can be an image generation task for generating an image in accordance with a distribution of a set of training images, where the input is a conditioning input, e.g., a sequence of text, a sequence of intensity values from a lower-resolution image, or an input identifying a target object class for the generated image, and the output is a sequence of intensity value for the pixels of an image.

As another example, the task can be an agent control task, where the input is a sequence of observations or other data characterizing states of an environment and the output defines an action to be performed by the agent in response to the most recent data in the sequence. The agent can be, e.g., a real-world or simulated robot, a control system for an industrial facility, or a control system that controls a different kind of agent.

As another example, the task can be a genomics task, where the input is a sequence representing a fragment of a DNA sequence or other molecule sequence and the output is either an embedding of the fragment for use in a downstream task, e.g., by making use of an unsupervised learning technique on a data set of DNA sequence fragments, or an output for the downstream task. Examples of downstream tasks include promoter site prediction, methylation analysis, predicting functional effects of non-coding variants, and so on.

As another example, the system can be part of a computer code generation system and can receive a context sequence that is a text description of a desired piece of code or a snippet of computer code in a programming language and generate an output sequence of computer code, e.g., a snippet of code that is described by the context sequence or a snippet of code that follows the context sequence in a computer program.

In some cases, the machine learning task is a combination of multiple individual machine learning tasks, i.e., the system is configured to perform multiple different individual machine learning tasks, e.g., two or more of the machine learning tasks mentioned above. For example, the system can be configured to perform multiple individual natural language understanding tasks, with the network input including an identifier for the individual natural language understanding task to be performed on the network input.

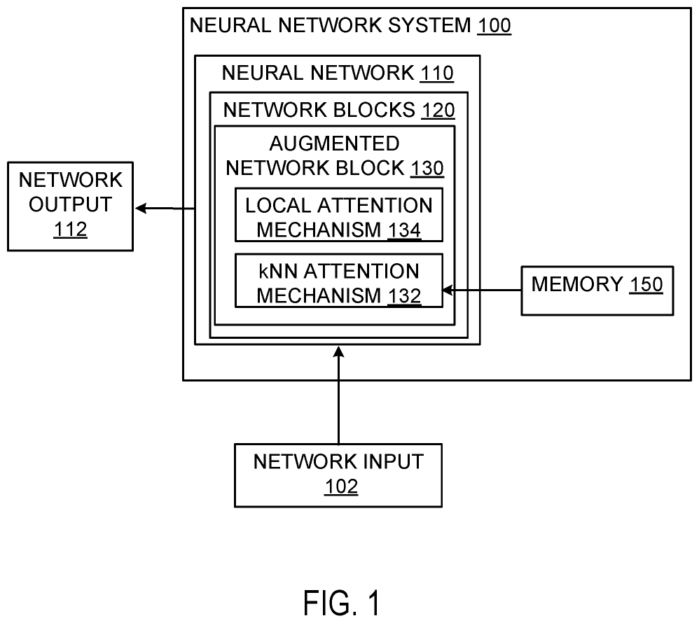

FIG. 1 shows an example neural network system 100. The neural network system 100 is an example of a system implemented as computer programs on one or more computers in one or more locations, in which the systems, components, and techniques described below can be implemented.

The system 100 is a system that, at any given processing iteration, processes a network input 102 for the processing iteration using a self-attention neural network 110 to generate a network output 112 characterizing the network input 102 for a machine learning task, e.g., one of the tasks described above.

In some implementations, each processing iteration corresponds to a different sub-sequence of a larger, original input sequence. In these implementations, the neural network 110 can process the multiple-sub-sequences one after the other, e.g., to generate a respective network output for each sub-sequence or to generate a single network output for all the subsequences, i.e., that is generated by the neural network 110 after processing the last Thus, at each processing iteration, the neural network 110 processes a corresponding sub-sequence.

In some other implementations, the neural network 110 is configured to autoregressively generate an output sequence including multiple output elements. That is, at each processing iteration, the neural network 110 processes a sub-sequence that includes the most-recently generated output elements in the output sequence to generate the next output element at the next position in the output sequence. Thus, for a given processing iteration, the current input sequence for the processing iteration and the previous input sequences processed at previous processing iterations can each be respective sub-sequences of the output sequence that include output elements already generated by the self-attention based neural network. The network output at the processing iteration that is generated in response to the input sequence (which can include, e.g., the n most recently generated output elements) can be the next output element of the output sequence.

The neural network 110 includes a sequence of one or more network blocks 120 that are each configured to process a block input that includes the network input or an intermediate representation of the network input and to generate a block output.

A “network block,” as used in this specification, is a collection of one or more neural network layers that receive an input (“a block input”) and process the input to generate an output (a “block output”).

For example, the first network block in the sequence of network blocks 120 can process the network input 102 or an embedded representation of the network input generated using an embedding layer to generate a block output that is an intermediate representation of the network input. Each subsequent network block 120 can then process the block output of the previous network block in the sequence.

In some implementations, the network output 112 for the neural network 110 is the block output of the final network block 120 in the sequence.

In some other implementations, the block output of the final network block 120 in the sequence is further processed using one or more neural network layers to generate the network output 112 for the neural network 110.

The sequence of network blocks 120 includes one or more augmented self-attention network blocks 130.

The augmented self-attention network blocks 130 are each configured to obtain a block input sequence and to execute two different self-attention mechanisms on the block input sequence.

The block input sequence has been generated from the input sequence (e.g., by processing the input sequence using one or more preceding network blocks of the self-attention based neural network) for the processing iteration and includes a respective block input at each of the multiple input positions in the input sequence.

The augmented self-attention network block 130 can apply a local self-attention mechanism 134 (also referred to as a “first” self-attention mechanism) to the block inputs of the input sequence to generate, for each block input, a respective first attention output.

For example, for each block input, the augmented self-attention network block 130 can determine a query from the block input, e.g., by processing the block input using one or more first neural network layers. For each block input, the augmented self-attention network block 130 can determine a key from the block input, e.g., by processing the block input using one or more second neural network layers.

For each block input, the augmented self-attention network block 130 can determine a value from the block input, e.g., by processing the block input using one or more third neural network layers.

Then, for each particular block input, the augmented self-attention network block 130 can generate the first attention output for the particular block input using the query for the particular block input, the respective keys of the block inputs in the block input sequence, and the respective values of the block inputs in the block input sequence. For instance, for each block input in the block input sequence, the augmented self-attention network block 130 can determine a weight by combining the query for the particular block input and the key for the block input, and determine a weighted sum of the values for the block inputs in the input sequence, where the value for each block input is weighted according to the determined weight of the block input.

When the neural network operates auto-regressively, the local self-attention mechanism 134 can be a causal self-attention mechanism, so that each position does not attend over any positions that are after the given position.

Self-attention mechanisms are described in more detail below.

The augmented self-attention network block 130 can apply a kNN self-attention mechanism 132 (also referred to as a “second self-attention mechanism”) to the block inputs of the input sequence to generate, for each block input, a respective second attention output.

The augmented self-attention network block 132 can leverage a memory 150 to augment the second self-attention mechanism 132, allowing the second self-attention mechanism 132 to apply self-attention across a larger sequence of network inputs than are included in the input sequence obtained by the self-attention neural network 110 at the generation iteration.

In particular, the memory 150 can store respective keys, and corresponding values, generated by the first attention mechanism 134 of the self-attention neural network block 130 at respective previous executions of the self-attention neural network 110, i.e., when the self-attention neural network 110 processed respective different input sequences at earlier generation iterations.

As described above, in some implementations, the current input sequence and the previous input sequences processed by the self-attention neural network 110 are each sub-sequences of the same input sequence. In these implementations, the self-attention neural network 110 can process the multiple-sub-sequences one after the other, e.g., to generate a respective network output for each sub-sequence or to generate a single network output for all the subsequences, and the memory 150 stores keys and values generated by the first attention mechanism 134 when processing earlier sub-sequences of the input sequence.

In some other implementations, the self-attention based neural network 110 is configured to autoregressively generate an output sequence including multiple output elements, and the current input sequence and the previous input sequences can each be respective sub-sequences of the output sequence that include output elements already generated by the self-attention based neural network. The network output generated in response to the current input sequence (which can include, e.g., the n most recently generated output elements) can be the next output element of the output sequence (e.g., the output that follows the n most recently generated output elements in the output sequence).

Thus, the memory 150 can store (key, value) pairs generated at respective previous executions of the first attention mechanism 134 of the self-attention neural network block 130, where the (key, value) pairs can be relevant to the current input sequence being processed by the self-attention based neural network 110. By obtaining one or more (key, value) pairs from the memory 150, as described in more detail below, the second self-attention mechanism 132 can thus attend over all of the sequences and improve the performance of the self-attention based neural network 110.

The number of key-value pairs that are stored in the memory 150 can depend on the size of the memory 150, i.e., on the amount of storage space allocated to the memory 150. For example, the system 100 can continue storing key-value pairs in the memory 150 until the memory 150 is full, i.e., until the memory capacity of the memory 150 has been met. Once this occurs, when adding key-value pairs to the memory 150, the system 100 can discard the same number of oldest key-value pairs from the memory 150, i.e., discard an equal number of oldest key-value pairs as new key-value pairs that are being added.

For each block input in the block input sequence, the second self-attention mechanism 132 can determine a query, e.g., by processing the block input using one or more neural network layers. In some implementations, for each block input, the query determined during the first attention mechanism and the query determined during the second attention mechanism 132 are the same. That is, the block 130 only needs to generate one set of queries to perform both attention mechanisms.

For each block input in the block input sequence, the second self-attention mechanism 132 can obtain one or more (key, value) pairs stored by the memory 150, using the query determined from the block input.

In particular, the second self-attention mechanism 132 can identify one or more, i.e., k, (key, value) pairs in the memory according to a similarity between the key and the query determined from the block input, where k is a fixed integer. For example, for each pair in the memory, the second self-attention mechanism 132 can determine a respective similarity score representing a similarity between the determined query and the key of the pair, and select the k pairs with the highest corresponding similarity score. As a particular example, the second-self attention mechanism 132 can select the one or more pairs for which a distance between the key of the pair and the determined query is minimized, according to a distance metric. That is, the keys stored in the memory and the determined query can have the same dimensionality n, and thus the second self-attention mechanism 132 can determine, for each key stored in the memory, a respective distance in an n-dimensional coordinate system between the determined query and the key.

In some implementations, the mechanism 132 can retrieve the k pairs using a k Nearest Neighbors (kNN) search over the pairs in the memory 150.

In some other implementations, to improve computational efficiency, the system can retrieve the k pairs using an approximate kNN search over the pairs in the memory 150.

The system can make use of any of a variety of conventional kNN or approximate kNN algorithms to perform the search. For example, the system can use a kNN or approximate kNN algorithm that is optimized for the types of devices that the system is using to perform the search.

Each (key, value) pair in the memory 150 corresponds to a respective different previous block input processed by the augmented self-attention network block at a respective previous time, and thus corresponds to a respective different previous network input of a previous input sequence processed by the self-attention based neural network 110. Thus, for each block input of the block input sequence, by selecting a strict subset of the (key, value) pairs stored in the memory 150, the second self-attention mechanism 132 selects a strict subset of the previous network inputs to attend over. In particular, by selecting (key, value) pairs for which the key and the determined query of the block input are most similar, the second self-attention mechanism 132 can select the (key, value) pairs that are likely to result in the largest second attention output for the block input. That is, for each block input in the block input sequence, the second self-attention mechanism 132 can identify the (key, value) pairs corresponding to respective previous network inputs that the block input “should” attend over.

Having obtained from the memory 150 the one or more respective (key, value) pairs corresponding to each block input, the second self-attention mechanism 132 can generate, for each block input, the second attention output using the determined query for the block output and the obtained (key, value) pairs for the block output. For example, for each particular block input in the block input sequence and for each key obtained from the memory for the particular block input, the augmented self-attention network block 130 can determine a weight by combining the query for the particular block input and the obtained key. The augmented self-attention network block 130 can then determine a weighted sum of the values obtained from the memory for the particular block input, where each value is weighted according to the determined weight for the corresponding key (i.e., the key in the same pair as the value).

In some implementations, the system 100 normalizes keys and queries when determining the weights values for the second attention mechanism 132 and optionally for the first attention mechanism 134.

That is, for each of the one or more previous keys, generating a respective weight value can include normalizing the determined product of the query and previous key using one or more of a dimensionality of the query, a sum of the products of the query and respective previous keys, or a sum of a set of second products computed between the query and respective second keys determined from the block inputs at the previous output positions in the subsequence. Normalizing keys and queries in this manner is described in more detail in Alex Henry, Prudhvi Raj Dachapally, Shubham Shantaram Pawar, and Yuxuan Chen. Query-key normalization for transformers. In EMNLP, 2020.

For each block input, the augmented self-attention network block 130 can combine the first attention output for the block input and the second attention output for the block input to generate a block output for the block input.

For example, the augmented self-attention network 130 block can determine the sum of the first attention output and the second attention output.

As another example, the augmented self-attention network block 130 can concatenate the first attention output and the second attention output.

As yet another example, the augmented self-attention network block 130 can combine the first attention output and the second attention output using a learned gate value. For example, the system can multiply the second attention output by the learned gate value and the first attention output by (one minus the learned gate value) and then sum the products.

In some implementations, the augmented block 130 performs multi-head attention and the first attention mechanism is a multi-head self-attention mechanism, where the augmented self-attention network block 130 generates, for each block input in the block input sequence, multiple respective initial first attention outputs as described above.

In these implementations, the second attention mechanism is also a multi-head self-attention mechanism, with each head of the second attention mechanism corresponding to one of the heads of the first attention mechanism. For a given head of the second attention mechanism, the system searches the memory 150 only for key-value pairs generated by the corresponding head of the second attention mechanism.

In these implementations, the block 130 can generate respective attention output elements as described above for each of the multiple heads and can then combine the attention output elements for the multiple heads to generate the final block output of the block 130, e.g., by concatenating, summing, or averaging the attention output elements or by applying a learned linear transformation to (a concatenation of) the attention output elements.

Thus, the output of the augmented self-attention network block 130 can be a block output sequence that includes the respective block outputs corresponding to each block input in the block input sequence.

In some implementations, the self-attention based neural network 110 includes one or more other network blocks, e.g., one or more other local self-attention network blocks and/or one or more feedforward network blocks.

In this specification, a local self-attention network block is a network block that obtains a block input sequence including multiple block inputs and applies self-attention to the block inputs, without accessing the memory 150. That is, the local self-attention network blocks do not attend over any network inputs outside of the network inputs used to generate the block inputs to the local self-attention network block.

While the augmented neural network blocks 130 can be arranged in any appropriate position within the sequence of blocks 120, in some implementations, only one of the blocks 120 is an augmented neural network block 130. For example, the augmented neural network block 130 can be one of the blocks 120 that is near the “top” of the sequence of the blocks 120.

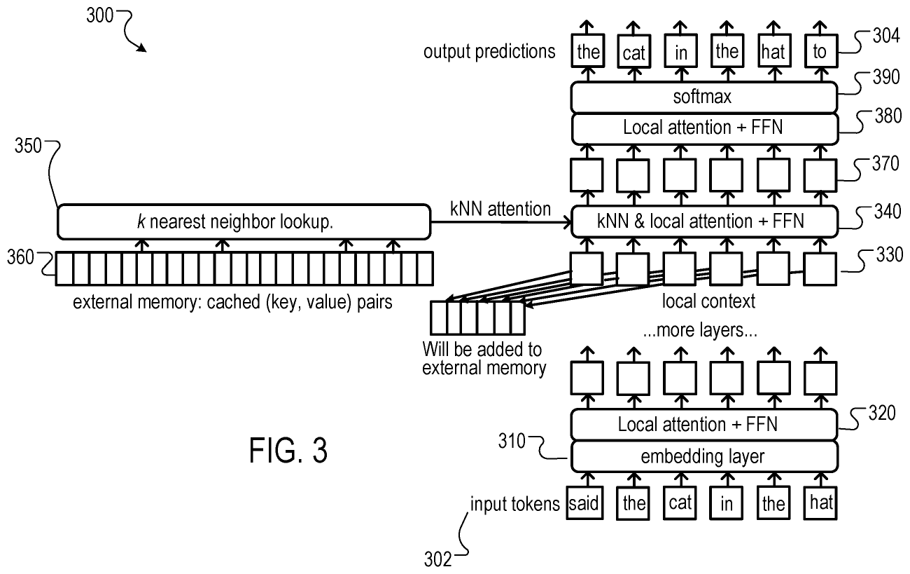

Such an example is described below with reference to FIG. 3.

Generally, each of the blocks 120 can include other components that perform other operations (other than attention operations). For example, some or all of the blocks 120 can include one or more of normalization components, residual connections, or feedforward neural network layers. Equivalently, these other components can be seen as separate blocks 120 in the sequence, i.e., separate from the blocks that perform attention operations.

A training system can train the self-attention based neural network 110 using any appropriate technique.

In some implementations, the memory 150 is non-differentiable. That is, the (key, value) pairs stored in the memory 150 are not updated during backpropagation or in response to any other parameter updates to the self-attention based neural network 110 during training. Making the memory 150 non-differentiable can significantly improve the efficiency of training by removing the computational requirement of updating the (key, value) pairs in the memory 150 or by backpropagating through the operation of adding the (key, value) pairs to the memory 150.

After training, the self-attention based neural network 110 can be deployed in any appropriate setting. For example, the self-attention neural network 110 can be deployed in a data center or on an edge device.

As described above, the self-attention neural network can be configured to operate in one of two modes.

In one mode, the neural network is performing a task that requires generating one or more outputs, e.g., classification outputs, for an input sequence. However, the input sequence is too long to be processed using the local attention mechanism of the neural network. Instead, the neural network partitions the input sequence into a plurality of sub-sequences and processes a respective sub-sequence at each generation iteration.

In the other mode, the neural network is performing a task that requires generating an output sequence autoregressively. However, the output sequence is too long to be processed using the local attention mechanism of the neural network. Instead, the neural network partitions the output sequence into a plurality of sub-sequences. At each generation iteration, the neural network generates the next output in the current sub-sequence, with the local attention mechanisms conditioned on the already generated outputs in the current sub-sequence. That is, for each subsequence and for each particular output position in the subsequence, the neural network processes an input sequence that includes any previous output elements at respective previous output positions preceding the particular output position in the subsequence.

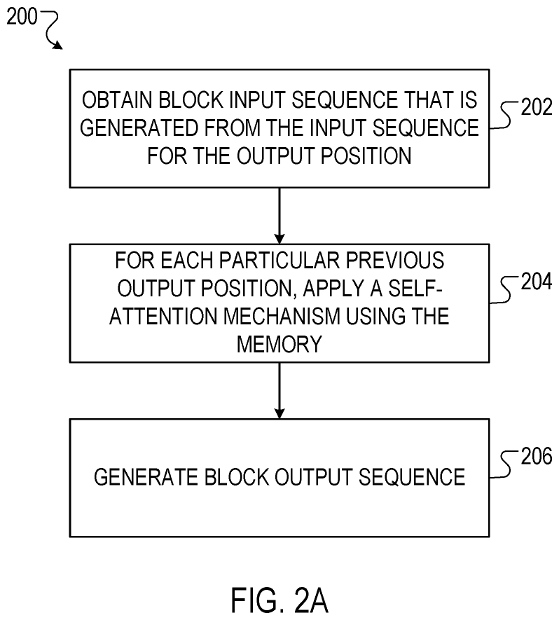

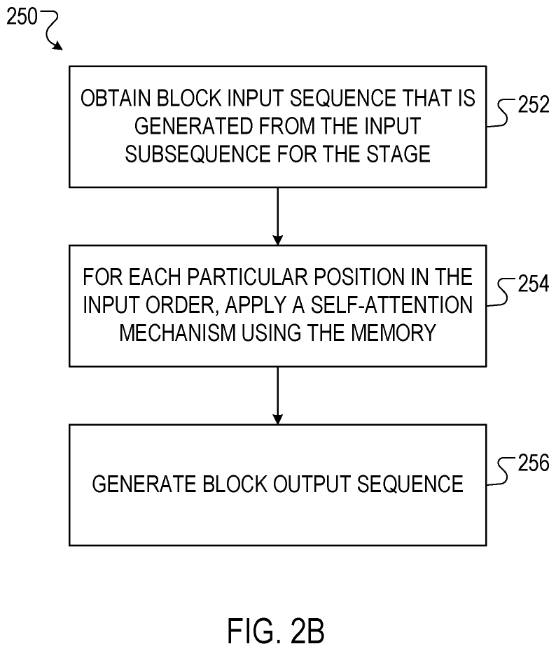

FIG. 2A is a flow diagram of an example process 200 for processing a block input using an augmented block when the neural network generates an output sequence auto-regressively. For convenience, the process 200 will be described as being performed by a system of one or more computers located in one or more locations. For example, an augmented block included in a neural network system, e.g., one of the augmented blocks 130 included in the neural network system 100 of FIG. 1, appropriately programmed, can perform the process 200.

In particular, the process 200 is performed by the augmented block for each output position in each sub-sequence after the first subsequence. In other words, for each subsequence and for each particular output position in the subsequence, the neural network processes an input sequence that includes any previous output elements at respective previous output positions preceding the particular output position in the subsequence, and, as part of this processing, each augmented block performs the process 200.

The augmented block obtains a block input sequence that is generated from the input sequence for the output position and that includes a respective block input at each of the previous output positions in the subsequence (step 202).

For each particular previous output position in the subsequence, the augmented block applies a self-attention mechanism over the block inputs at the previous output positions to generate a respective attention output for the particular previous output position (step 204).

Applying the self-attention mechanism includes determining a query from the block input at the particular previous output position, obtaining, from a memory configured to store previous keys and corresponding previous values generated by the neural network when generating previous subsequences preceding the subsequence in the output sequence, one or more particular previous keys and corresponding particular previous values according to a similarity between the determined query and the particular previous values, and using the query, previous keys, and previous values to generate the attention output for the particular previous output position.

The augmented block generates, from the attention outputs corresponding to respective previous output positions, a block output sequence that has a respective block output at each of the previous output positions in the subsequence (step 206).

In particular, as described above, the augmented block generally also applies the first attention mechanism over the output positions to generate another attention output for each of the output positions and, for each particular previous output position, combines (i) the attention output for the particular previous output position and (ii) the other attention output for the particular previous output position.

Once the neural network has generated the last output for the last position in a given subsequence, the system can provide, for each previous output position in the subsequence, the corresponding second key and second value to the memory for future stages. That is, the system can store, in the memory, the corresponding second key and second values generated by the local self-attention mechanism for the output positions for use in generating future subsequences.

FIG. 2B is a flow diagram of an example process 250 for processing a block input using an augmented block when the neural network generates a network output for a long input sequence. For convenience, the process 250 will be described as being performed by a system of one or more computers located in one or more locations. For example, an augmented block included in a neural network system, e.g., one of the augmented blocks 130 included in the neural network system 100 of FIG. 1, appropriately programmed, can perform the process 250.

In particular, the process 250 is performed by the augmented block for each subsequence of the input sequence after the first subsequence. In other words, at each of multiple stages, the system processes a respective different input subsequence of the input sequence. In some implementations, the system generates one or more network outputs for each subsequence. In some other implementations, the system generates a network output only for the last subsequence, i.e., the system processes the earlier subsequences to provide “context” for the prediction made after processing the last subsequence.

Each input subsequence has a respective network input at each of a plurality of input positions in an input order and each augmented block performs the process 250 at each stage, i.e., for each input subsequence.

The block obtains a block input sequence that is generated from the input subsequence for the stage and that includes a respective block input at each of the plurality of input positions (step 252).

For each particular input position in the input order, the system applies a self-attention mechanism over the block inputs at the plurality of input positions to generate a respective attention output for the particular input position (step 254). To apply the self-attention mechanism, the system determines a query from the block input at the particular input position, obtains, from a memory configured to store previous keys and corresponding previous values generated by the neural network at respective previous stages, one or more particular previous keys and corresponding particular previous values according to a similarity between the determined query and the particular previous values, and uses the query, previous keys, and previous values to generate the attention output for the particular input position.

The block then generates, from the attention outputs corresponding to respective input positions, a block output sequence that has a respective block output at each of the plurality of input positions (step 256).

FIG. 3 shows an example architecture of the neural network 110.

In particular, FIG. 3 shows the processing of a current input sequence 302 (“said the cat in the hat”) as part of predicting the next element 304 (“to”).

As shown in FIG. 3, the neural network 110 includes multiple local attention blocks and a single augmented neural network block 340. In the example of FIG. 3, each local and augmented attention block is followed by a feedforward neural network (FNN) block. Alternatively, this can be viewed as having each attention block also include a component that performs the operations of the FFN block.

More specifically, the neural network includes an embedding layer 310, a sequence of blocks, and an output softmax layer 390. The sequence blocks includes an initial local attention block 320, additional layer blocks, the augmented neural network block 340, and a final local attention block 380.

The augmented neural network block 340 receives a block input 330 generated by the preceding block in the sequence and generates, using the block input 330 and an external memory 360 that stores cached (key, value) pairs, a block output 370.

In particular, the augmented neural network block 330 performs a local attention mechanism over the block input 330 and a kNN attention mechanism over the block input 330 and the cached (key, value) pairs that are stored in the memory 360.

To perform the kNN attention mechanism, for each position in the block input, the block 330 performs a k nearest neighbor lookup (or an approximate k nearest neighbor lookup) 350 using the query for the position to identify k cached (key, value) pairs. For each position, the block 330 then performs attention using the query and the k cached pairs for the position to generate the output of the kNN attention mechanism.

The block 330 can then generate the block output 370 by combining the outputs of the local attention mechanism and the kNN attention mechanism.

Once the current subsequence has been processed, the block 330 then adds the keys and values generated by the local attention mechanism to the memory 360 for use at the next stage, i.e., when processing the next sub-sequence.

Prior to using the neural network to perform the machine learning task, a training system trains the neural network to perform the task, i.e., to determine trained values of the parameters of the neural network, i.e., of the blocks in the sequence, the output layer(s), and the embedding layer used to generate the input to the first block in the sequence. For example, the training system can train the neural network from scratch on training data for the task to minimize a loss function for the task, e.g., a cross-entropy loss, a negative log likelihood loss, and so on using conventional machine learning techniques. As another example, the training system can first pre-train the neural network on an unsupervised objective and then fine-tune the neural network on the training data for the task. As yet another example, the training system can train the neural network on both unlabeled data and the training data for the task through semi-supervised learning.

During training, the training system can incorporate any number of techniques to improve the speed, the effectiveness, or both of the training process. For example, the system can use dropout, label smoothing, or both to reduce overfitting. As another example, the system can perform the training using a distributed architecture that trains multiple instances of the neural network in parallel. Moreover, as described above, the system can first pre-train the neural network on a large unsupervised data set through unsupervised learning, e.g., to minimize a BERT loss or other unsupervised loss, and then fine-tune the neural network on task-specific training data to optimize the loss function for the task.

An “embedding,” as used in this specification is a vector of numeric values, e.g., floating point or other type of numeric values, that has a predetermined dimensionality, e.g., has a predetermined number of values.

A self-attention block, as referred to above, is a neural network layer that includes an attention mechanism that operates over the self-attention block input (or an input derived from the layer input) to generate the self-attention block output. A self-attention mechanism may be causally masked so that any given position in an input sequence does not attend over (e.g. use data from) any positions after the given position in the input sequence. There are many different possible attention mechanisms. Some examples of self-attention layers including attention mechanisms, are described in Vaswani et al. “Attention is all you need”, 31st Conference on Neural Information Processing Systems (NIPS 2017), Long Beach, CA, USA; Colin Raffel, Noam Shazeer, Adam Roberts, Katherine Lee, Sharan Narang, Michael Matena, Yanqi Zhou, Wei Li, and Peter J Liu. Exploring the limits of transfer learning with a unified text-to-text transformer. arXiv preprint arXiv: 1910.10683, 2019; Daniel Adiwardana, Minh-Thang Luong, David R. So, Jamie Hall, Noah Fiedel, Romal Thoppilan, Zi Yang, Apoorv Kulshreshtha, Gaurav Nemade, Yifeng Lu, and Quoc V. Le. Towards a human-like open-domain chatbot. CoRR, abs/2001.09977, 2020; and Tom B Brown, Benjamin Mann, Nick Ryder, Melanie Subbiah, Jared Kaplan, Prafulla Dhariwal, Arvind Neelakantan, Pranav Shyam, Girish Sastry, Amanda Askell, et al. Language models are few-shot learners. arXiv preprint arXiv: 2005.14165, 2020.

Generally, an attention mechanism maps a query and a set of key-value pairs to an output, where the query, keys, and values are all vectors. The output is computed as a weighted sum of the values, where the weight assigned to each value is computed by a compatibility function, e.g. a dot product or scaled dot product, of the query with the corresponding key.

Generally, a self-attention mechanism is configured to relate different positions in the same sequence to determine a transformed version of the sequence as an output. For example the attention layer input may comprise a vector for each element of the input sequence. These vectors provide an input to the self-attention mechanism and are used by the self-attention mechanism to determine a new representation of the same sequence for the attention layer output, which similarly comprises a vector for each element of the input sequence. An output of the self-attention mechanism may be used as the attention layer output, or it may be processed by one or more of feed-forward layers, skip connections, or normalization operations to provide the attention layer output.

In some implementations the attention mechanism is configured to apply each of a query transformation e.g. defined by a matrix W^{Q}, a key transformation e.g. defined by a matrix W^{K}, and a value transformation e.g. defined by a matrix W^{V}, to the attention layer input which is the input data X to the attention layer, to derive a query matrix Q=XW^{Q} that includes a respective query for each vector in the input sequence, key matrix K=XW^{K} that includes a respective key for each vector in the input sequence, and value matrix V=XW^{V} that includes a respective value for each vector in the input sequence, which are used determine an attended sequence for the output. For example the attention mechanism may be a dot product attention mechanism applied by applying each query vector to each key vector to determine respective weights for each value vector, then combining the value vectors using the respective weights to determine the self-attention layer output for each element of the input sequence. The self-attention layer output may be scaled by a scaling factor e.g. by the square root of the dimensions of the queries and keys, to implement scaled dot product attention. Thus, for example, an output of the attention mechanism may be determined as

$$softmax ( \frac{Q {K}^{T}}{\sqrt{d}} ) V$$

where d is a dimension of the key (and value) vector. In another implementation the attention mechanism be comprise an “additive attention” mechanism that computes the compatibility function using a feed-forward network with a hidden layer. The output of the attention mechanism may be further processed by one or more fully-connected, feed forward neural network layers.

The attention mechanism may implement multi-head attention, that is, it may apply multiple different attention mechanisms in parallel. The outputs of these may then be combined, e.g. concatenated, with a learned linear transformation applied to reduce to the original dimensionality if necessary.

In some implementations, the “local” self-attention mechanism applied by the augmented blocks, the “local” self-attention mechanism applied by the other self-attention blocks in the neural network, or both, can be a self-attention mechanism that has a modified architecture to (partially) account for generating or process longer sequences, e.g., a transformer-XL (T-XL) machine learning model. After autoregressively generating N output tokens in the output sequence, a T-XL model (or other model) can store a representation of the N output tokens in T-XL memory. The T-XL model can store a respective representation of multiple segments of N tokens in T-XL memory. Each time after generating an additional N output tokens, the T-XL can store a representation of the additional N output tokens in T-XL memory, where the representation was generated by the T-XL model. The T-XL model can autoregressively generate each output token in the output sequence by processing a combined sequence of at least the respective representations already in the T-XL memory and any output tokens both preceding the output token and not yet stored in the T-XL memory as part of a respective representation. This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub programs, or portions of code. A computer program can be deployed to be executed on one computer or on multiple computers that are located at one site or distributed across multiple sites and interconnected by a data communication network.

In this specification, the term “database” is used broadly to refer to any collection of data: the data does not need to be structured in any particular way, or structured at all, and it can be stored on storage devices in one or more locations. Thus, for example, the index database can include multiple collections of data, each of which may be organized and accessed differently.

Similarly, in this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, i.e., inference, workloads.

Machine learning models can be implemented and deployed using a machine learning framework, e.g., a TensorFlow framework, a Microsoft Cognitive Toolkit framework, an Apache Singa framework, or an Apache MXNet framework.

Embodiments of the subject matter described in this specification can be implemented in a computing system that includes a back end component, e.g., as a data server, or that includes a middleware component, e.g., an application server, or that includes a front end component, e.g., a client computer having a graphical user interface, a web browser, or an app through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A system comprising one or more computers and one or more storage devices storing instructions that when executed by the one or more computers cause the one or more computers to implement a neural network configured to process a network input to generate an output sequence comprising a respective output element at each of multiple output positions in an output order,
the output sequence being partitioned into a plurality of subsequences each comprising a different subset of the output elements at respective output positions,
the generating comprising, for each subsequence and for each particular output position in the subsequence, processing an input sequence comprising any previous output elements at respective previous output positions preceding the particular output position in the subsequence,
the neural network comprising a sequence of one or more network blocks, the sequence comprising at least one self-attention network block configured to perform, for each output position in each subsequence after a first subsequence of the output sequence, operations comprising:
obtaining a block input sequence generated from the input sequence for the output position and comprising a respective block input at each of the previous output positions in the subsequence;
for each particular previous output position in the subsequence, applying a self-attention mechanism over the block inputs at the previous output positions to generate a respective attention output for the particular previous output position, wherein applying the self-attention mechanism comprises:
determining a query from the block input at the particular previous output position,
obtaining, from a memory configured to store previous keys and corresponding previous values generated by the neural network when generating previous subsequences preceding the subsequence in the output sequence, one or more particular previous keys and corresponding particular previous values according to a similarity between the determined query and the particular previous values, and
using the query, previous keys, and previous values to generate the attention output for the particular previous output position; and
generating, from the attention outputs corresponding to respective previous output positions, a block output sequence comprising a respective block output at each of the previous output positions in the subsequence.

2. The system of claim 1, wherein:
the self-attention mechanism is a first self-attention mechanism, and
the at least one self-attention network block is configured to perform, for each output position in each subsequence, operations further comprising:
for each particular previous output position in the subsequence, applying a second self-attention mechanism over the block inputs at the previous output positions to generate a respective second attention output for the particular previous output position, wherein applying the second self-attention mechanism comprises:
determining a second query from the block input at the particular previous output position,
determining second keys from the block inputs at the plurality of previous output positions,
determining second values from the block inputs at the plurality of previous output positions, and
using the second query, second keys, and second values to generate the second attention output for the particular previous output position.

3. The system of claim 2, wherein, for each particular previous output position, the corresponding query and second query are the same.

4. The system of claim 2, wherein generating the block output sequence comprises, for each particular previous output position, combining (i) the attention output for the particular previous output position and (ii) the second attention output for the particular previous output position.

5. The system of claim 4, wherein, for each particular previous output position, combining (i) the attention output for the particular previous output position and (ii) the second attention output for the particular previous output position comprises summing the attention output and the second attention output.

6. The system of claim 2, the operations further comprising:
providing, for each previous output position in the subsequence, the corresponding second key and second value to the memory for future stages.

7. The system of claim 1, wherein obtaining one or more particular previous keys and corresponding particular previous values according to a similarity between the determined query and the particular previous values comprises:
determining, from the previous keys stored by the memory, the one or more particular previous keys that are closest to the determined query according to a distance metric; and
obtaining (i) the one or more determined particular previous keys and (ii) for each determined particular previous key, the corresponding particular previous value stored by the memory.

8. The system of claim 1, wherein using the query, previous keys, and previous values to generate the attention output for the particular previous output position comprises:
for each of the one or more previous keys, generating a respective weight value by determining a product of the query and the previous key; and
computing a weighted sum of the previous values, wherein each previous value is weighted according to the weight value generated from the corresponding previous key.

9. The system of claim 8, wherein, for each of the one or more previous keys, generating a respective weight value comprises normalizing the determined product of the query and previous key using one or more of:
a dimensionality of the query,
a sum of the products of the query and respective previous keys, or
a sum of a set of second products computed between the query and respective second keys determined from the block inputs at the previous output positions in the subsequence.

10. The system of claim 1, wherein the sequence of network blocks further comprises one or more local self-attention network blocks that are each configured to perform, at each stage, operations comprising, for each output position in each subsequence after a first subsequence of the output sequence:
obtaining a local self-attention block input sequence generated from the input sequence for the output position and comprising a respective local self-attention block input at each of the previous output positions in the subsequence;
for each particular previous output position in the subsequence, applying a third self-attention mechanism over the local self-attention block inputs at the previous output positions to generate a respective third attention output for the particular previous output position, wherein applying the third self-attention mechanism comprises:
determining a third query from the local self-attention block input at the particular previous output position,
determining third keys from the local self-attention block inputs at the previous output positions in the subsequence,
determining third values from the local self-attention block inputs at the previous output positions in the subsequence, and
using the third query, third keys, and third values to generate the third attention output for the particular previous output position.

11. A system comprising one or more computers and one or more storage devices storing instructions that when executed by the one or more computers cause the one or more computers to implement a neural network configured to process an input sequence to generate a network output,
the processing comprising, at each of multiple stages, processing a respective different input subsequence of the input sequence, each input subsequence having a respective network input at each of a plurality of input positions in an input order,
the neural network comprising a sequence of one or more network blocks, the sequence comprising at least one self-attention network block configured to perform, at each stage, operations comprising:
obtaining a block input sequence generated from the input subsequence for the stage and comprising a respective block input at each of the plurality of input positions;
for each particular input position in the input order, applying a self-attention mechanism over the block inputs at the plurality of input positions to generate a respective attention output for the particular input position, wherein applying the self-attention mechanism comprises:
determining a query from the block input at the particular input position,
obtaining, from a memory configured to store previous keys and corresponding previous values generated by the neural network at respective previous stages, one or more particular previous keys and corresponding particular previous values according to a similarity between the determined query and the particular previous values, and
using the query, previous keys, and previous values to generate the attention output for the particular input position; and
generating, from the attention outputs corresponding to respective input positions, a block output sequence comprising a respective block output at each of the plurality of input positions.

12. The system of claim 11, wherein:
the self-attention mechanism is a first self-attention mechanism, and
the at least one self-attention network block is configured to perform, at each stage, operations further comprising:
for each particular input position in the input order, applying a second self-attention mechanism over the block inputs at the plurality of input positions to generate a respective second attention output for the particular input position, wherein applying the second self-attention mechanism comprises:
determining a second query from the block input at the particular input position,
determining second keys from the block inputs at the plurality of input positions,
determining second values from the block inputs at the plurality of input positions, and
using the second query, second keys, and second values to generate the second attention output for the particular input position.

13. The system of claim 12, wherein, for each particular input position, the corresponding query and second query are the same.

14. The system of claim 12, wherein generating the block output sequence comprises, for each particular input position, combining (i) the attention output for the particular input position and (ii) the second attention output for the particular input position.

15. The system of claim 14, wherein, for each particular input position, combining (i) the attention output for the particular input position and (ii) the second attention output for the particular input position comprises summing the attention output and the second attention output.

16. The system of claim 12, the operations further comprising:
providing, for each input position of the plurality of input positions, the corresponding second key and second value to the memory for future stages.

17. The system of claim 11, wherein obtaining one or more particular previous keys and corresponding particular previous values according to a similarity between the determined query and the particular previous values comprises:
determining, from the previous keys stored by the memory, the one or more particular previous keys that are closest to the determined query according to a distance metric; and
obtaining (i) the one or more determined particular previous keys and (ii) for each determined particular previous key, the corresponding particular previous value stored by the memory.

18. The system of claim 11, wherein using the query, previous keys, and previous values to generate the attention output for the particular input position comprises:
for each of the one or more previous keys, generating a respective weight value by determining a product of the query and the previous key; and
computing a weighted sum of the previous values, wherein each previous value is weighted according to the weight value generated from the corresponding previous key.

19. The system of claim 18, wherein, for each of the one or more previous keys, generating a respective weight value comprises normalizing the determined product of the query and previous key using one or more of:
a dimensionality of the query,
a sum of the products of the query and respective previous keys, or
a sum of a set of second products computed between the query and respective second keys determined from the block inputs at the plurality of input positions.

20. The system of claim 11, wherein the sequence of network blocks further comprises one or more local self-attention network blocks that are each configured to perform, at each stage, operations comprising:
obtaining a local self-attention block input sequence generated from the input subsequence for the stage and comprising a respective local self-attention block input at each of the plurality of input positions;
for each particular input position in the input order, applying a third self-attention mechanism over the local self-attention block inputs at the plurality of input positions to generate a respective third attention output for the particular input position, wherein applying the third self-attention mechanism comprises:
determining a third query from the local self-attention block input at the particular input position,
determining third keys from the local self-attention block inputs at the plurality of input positions,
determining third values from the local self-attention block inputs at the plurality of input positions, and
using the third query, third keys, and third values to generate the third attention output for the particular input position.

21. (canceled)

22. A method performed by one or more computers, the method comprising:
receiving a network input; and
processing the network input to generate an output sequence comprising a respective output element at each of multiple output positions in an output order,
the output sequence being partitioned into a plurality of subsequences each comprising a different subset of the output elements at respective output positions,
the generating comprising, for each subsequence and for each particular output position in the subsequence, processing an input sequence comprising any previous output elements at respective previous output positions preceding the particular output position in the subsequence using a neural network,
the neural network comprising a sequence of one or more network blocks, the sequence comprising at least one self-attention network block configured to perform, for each output position in each subsequence after a first subsequence of the output sequence, operations comprising:
obtaining a block input sequence generated from the input sequence for the output position and comprising a respective block input at each of the previous output positions in the subsequence;
for each particular previous output position in the subsequence, applying a self-attention mechanism over the block inputs at the previous output positions to generate a respective attention output for the particular previous output position, wherein applying the self-attention mechanism comprises:
determining a query from the block input at the particular previous output position,
obtaining, from a memory configured to store previous keys and corresponding previous values generated by the neural network when generating previous subsequences preceding the subsequence in the output sequence, one or more particular previous keys and corresponding particular previous values according to a similarity between the determined query and the particular previous values, and
using the query, previous keys, and previous values to generate the attention output for the particular previous output position; and
generating, from the attention outputs corresponding to respective previous output positions, a block output sequence comprising a respective block output at each of the previous output positions in the subsequence.

23. The method of claim 22, wherein:
the self-attention mechanism is a first self-attention mechanism, and
the at least one self-attention network block is configured to perform, for each output position in each subsequence, operations further comprising:
for each particular previous output position in the subsequence, applying a second self-attention mechanism over the block inputs at the previous output positions to generate a respective second attention output for the particular previous output position, wherein applying the second self-attention mechanism comprises:
determining a second query from the block input at the particular previous output position,
determining second keys from the block inputs at the plurality of previous output positions,
determining second values from the block inputs at the plurality of previous output positions, and
using the second query, second keys, and second values to generate the second attention output for the particular previous output position.

24. The method of claim 23, wherein, for each particular previous output position, the corresponding query and second query are the same.

25. The method of claim 23, wherein generating the block output sequence comprises, for each particular previous output position, combining (i) the attention output for the particular previous output position and (ii) the second attention output for the particular previous output position.

26. The method of claim 23, the operations further comprising:
providing, for each previous output position in the subsequence, the corresponding second key and second value to the memory for future stages.

27. The method of claim 22, wherein obtaining one or more particular previous keys and corresponding particular previous values according to a similarity between the determined query and the particular previous values comprises:
determining, from the previous keys stored by the memory, the one or more particular previous keys that are closest to the determined query according to a distance metric; and
obtaining (i) the one or more determined particular previous keys and (ii) for each determined particular previous key, the corresponding particular previous value stored by the memory.

28. The method of claim 22, wherein using the query, previous keys, and previous values to generate the attention output for the particular previous output position comprises:
for each of the one or more previous keys, generating a respective weight value by determining a product of the query and the previous key; and
computing a weighted sum of the previous values, wherein each previous value is weighted according to the weight value generated from the corresponding previous key.

29. The method of claim 28, wherein, for each of the one or more previous keys, generating a respective weight value comprises normalizing the determined product of the query and previous key using one or more of:
a dimensionality of the query,
a sum of the products of the query and respective previous keys, or
a sum of a set of second products computed between the query and respective second keys determined from the block inputs at the previous output positions in the subsequence.
